(19) United States
(12) Patent Application Publication
(10) Pub. No.: US 2022/0177273 A1
(43) Pub. Date: Jun. 9, 2022

(54) AUTONOMOUS ELEVATOR CAR MOVER CONFIGURED FOR DERAILMENT PREVENTION

(71) Applicant: Otis Elevator Company, Farmington, CT (US)

(72) Inventors: Sam Wong, Bridgeport, CT (US); Stephen E. Delage, Newington, CT (US)

(21) Appl. No.: 17/112,425

(22) Filed: Dec. 4, 2020

(51) Int. Cl. B66B 9/00; B66B 1/32; B66B 9/02

(52) U.S. Cl. CPC B66B 9/003; B66B 2201/30; B66B 9/02; B66B 1/32

(57) ABSTRACT

Disclosed is an elevator system configured for controlling motion of an elevator car in a hoistway, the hoistway having a transfer station end that is configured to receive a transfer station, the system having: a car mover is operationally connected to the elevator car for moving the elevator car in the hoistway, wherein the car mover is configured to stop while approaching a transfer station when the transfer station is unavailable.

### BACKGROUND

Embodiments described herein relate to a multi-car elevator system and more specifically to an autonomous elevator car mover configured for derailment prevention.

An autonomous elevator car mover may use motor-driven wheels to propel the elevator car up and down on vertical track beams, which may be I-beams, having respective webs that form front and back track surfaces. Two elements to this system include the elevator car which will be guided by rollers guides on traditional T-rails, and the autonomous car mover which will house two (2) to four (4) motor-driven wheels. An operational goal of the car mover is for the wheels to prevent derailment when a transfer station is unavailable.

### BRIEF SUMMARY

Disclosed is an elevator system configured for controlling motion of an elevator car in a hoistway, the hoistway having a transfer station end that is configured to receive a transfer station, the system including: a car mover is operationally connected to the elevator car for moving the elevator car in the hoistway, wherein the car mover is configured to stop while approaching a transfer station when the transfer station is unavailable.

In addition to one or more aspects of the system, or as an alternate, the car mover is configured to stop by controlling one or more of primary and safety brakes operationally connected to the car mover, and power for moving in the hoistway.

In addition to one or more aspects of the system, or as an alternate, the car mover is configured to stop upon determining that it is within a predetermined distance of the transfer station.

In addition to one or more aspects of the system, or as an alternate, the car mover is configured to determine from sensor data that it is within the predetermined distance of the transfer station, wherein the sensor data is obtained from a sensor that is operationally connected to the car mover.

In addition to one or more aspects of the system, or as an alternate, the car mover is configured to determine that it is within a predetermined distance of the transfer station when a limit switch, operationally connected to the car mover, is engaged by an actuator, within the predetermined distance of the transfer station.

In addition to one or more aspects of the system, or as an alternate, a motion buffer is configured to engage a barrier that is located adjacent the transfer station end of the hoistway and is deployed into a travel path of the car mover or the elevator car when the transfer station is unavailable, wherein when the motion buffer engages the barrier, the car mover stops, and wherein motion buffer is configured to react forces generated from engagement of the motion buffer with the barrier.

In addition to one or more aspects of the system, or as an alternate, a barrier is located adjacent the transfer station end of the hoistway and is deployed into a travel path of the car mover or the elevator car when the transfer station is unavailable, wherein upon engaging the barrier, the car mover stops, wherein the barrier is configured to react forces generated from engagement with the barrier.

In addition to one or more aspects of the system, or as an alternate, wherein one or both of the barrier and buffer is configured for being in a deployed state when the transfer station is unavailable and a retracted state when the transfer station is available, wherein in the deployed state, the barrier is extended into the travel path of the car mover or the elevator car to block access to the transfer station, and in the retracted state, the barrier is outside of the travel path of the car mover or the elevator car.

In addition to one or more aspects of the system, or as an alternate, the barrier is configured for automatically transition into the deployed state when the transfer station is unavailable.

In addition to one or more aspects of the system, or as an alternate, the transfer station end is a lower transfer station end and the transfer station is a lower transfer station, and wherein the hoistway defines an upper transfer station end that is configured to receive an upper transfer station, and wherein the car mover is configured to stop while approaching the upper transfer station upon determining that the upper transfer station is unavailable.

In addition to one or more aspects of the system, or as an alternate, the motion buffer is a lower motion buffer and the barrier is a lower barrier, and a upper motion buffer is operationally connected to the elevator car and configured to engage a upper barrier that is located adjacent the upper transfer station and is deployed into the travel path of the car mover or the elevator car when the upper transfer station is unavailable, wherein the car mover is configured to stop when the upper motion buffer engages the upper barrier.

Further disclosed is a method of operating an elevator system to control motion of an elevator car in a hoistway, the hoistway having a transfer station end that is configured to receive a transfer station, the method including: moving the elevator car in the hoistway via a car mover operationally connected to the elevator car, stopping, via the car mover, while approaching the transfer station when the transfer station is unavailable.

In addition to one or more aspects of the method, or as an alternate, the method includes stopping, via the car mover, by controlling one or more of primary and safety brakes operationally connected to the car mover, and power for moving the car mover.

In addition to one or more aspects of the method, or as an alternate, the method includes stopping, via the car mover, upon determining that it is within a predetermined distance of the transfer station.

In addition to one or more aspects of the method, or as an alternate, the method includes determining, by the car mover, from sensor data indicative of the car mover being within the predetermined distance of the transfer station, wherein the sensor data is obtained from a sensor that is operationally connected to the car mover.

In addition to one or more aspects of the method, or as an alternate, the method includes determining, by the car mover, that it is within a predetermined distance of the transfer station when a limit switch, operationally connected to the car mover, is engaged by an actuator, within the predetermined distance of the transfer station.

In addition to one or more aspects of the method, or as an alternate, the method includes engaging a motion buffer with a barrier that is located adjacent the transfer station and is deployed into a travel path of the car mover or the elevator car when the transfer station is unavailable, stopping, by the car mover, upon the motion buffer engaging the barrier, and reacting forces generated from engagement of the motion buffer with the barrier via the motion buffer.

In addition to one or more aspects of the method, or as an alternate, the method includes engaging a barrier that is located adjacent the transfer station and is deployed into a travel path of the car mover or the elevator car when the transfer station is unavailable, stopping, by the car mover, upon engagement with the barrier, and reacting, by the barrier, forces generated from engagement with the barrier.

In addition to one or more aspects of the method, or as an alternate, the method includes one or both of the barrier and the motion buffer being in one of a deployed state when the transfer station is unavailable and a retracted state when the transfer station is available, wherein in the deployed state, the barrier is extended into the travel path of the car mover or the elevator car to block access to the transfer station, and in the retracted state, the barrier is outside of the travel path of the car mover or the elevator car.

In addition to one or more aspects of the method, or as an alternate, the method includes the barrier automatically transitioning into the deployed state when the transfer station is unavailable.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic of elevator cars and car movers in a hoistway lane according to an embodiment;

FIG. 2 shows a car mover according to an embodiment;

FIG. 3 shows a hoistway configured with transfer stations according to an embodiment;

FIG. 4 shows a lane of the hoistway of FIG. 3, including motion stopping implements for a car mover within the hoistway; and

FIG. 5 is a flow chart showing an operation of a car mover that utilizes motion stopping implements according to an embodiment.

### DETAILED DESCRIPTION

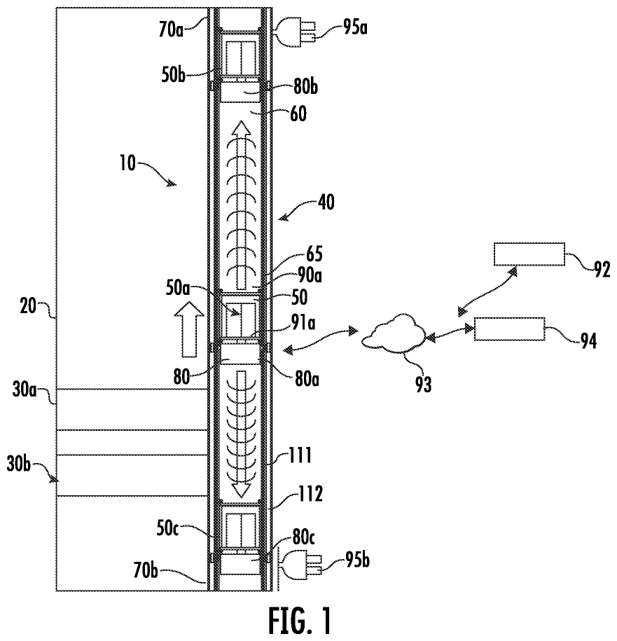

FIG. 1 depicts a self-propelled or ropeless elevator system (elevator system) 10 in an exemplary embodiment that may be used in a structure or building 20 having multiple levels or floors 30a, 30b. Elevator system 10 includes a hoistway 40 (or elevator shaft) defined by boundaries carried by the building 20, and a plurality of cars 50a-50c adapted to travel in a hoistway lane 60 along an elevator car track 65 (which may be a T-rail) in any number of travel directions (e.g., up and down). The hoistway 40 may also include a top end terminus 70a and a bottom end terminus 70b.

For each of the cars 50a-50c, the elevator system 10 includes one of a plurality of car mover systems (car movers) 80a-80c (otherwise referred to as a beam climber system, or beam climber, for reasons explained below). The elevator car 50a and its car mover 80a may be generically referred to herein as an elevator car 50 and its car mover 80.

The car mover 80 is configured to move along a car mover track beam 111 (otherwise referred to as a track beam or guide beam, and which may be an I-beam), and specifically along a car mover track surface 112 (otherwise referred to as a track) of the track beam 111. This operation moves the elevator car 50 along the hoistway lane 60. The car mover 80 may be positioned to engage the top 90a of the car 50, the bottom 91a of the car 50, or any other desired location. In FIG. 1, the car mover 80 engages the bottom 91a of the car 50.

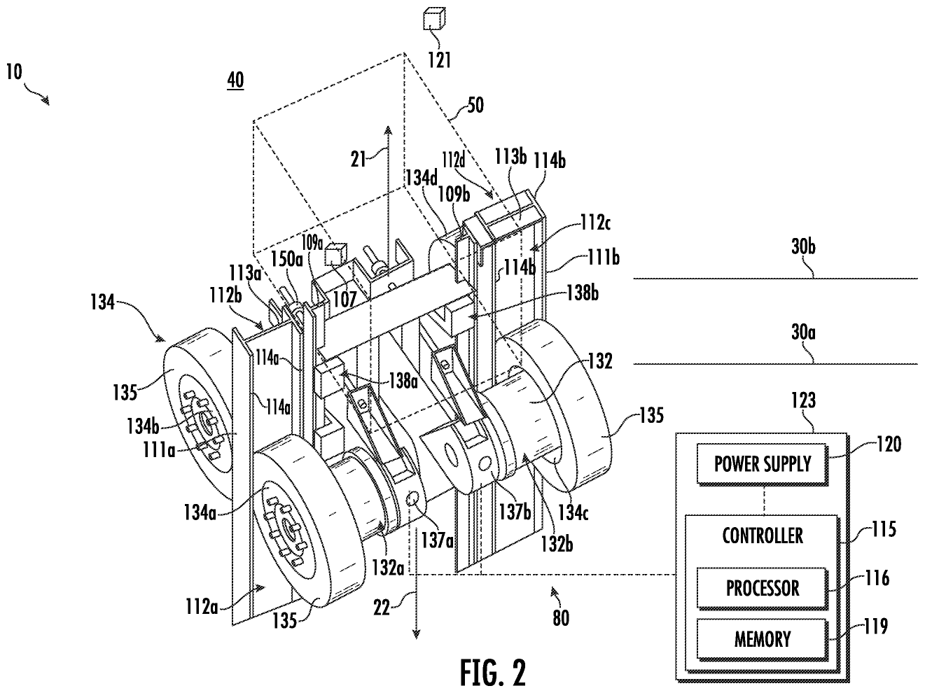

A supervisory hub 92 (also referred to as a supervisory controller) for the elevator system 10 may be included that may be configured with sufficient processors, discussed below, for communicating with a car mover controller 115 (FIG. 1, discussed below) of the car mover 80. The supervisory controller 92 may provide a certain level of supervisory instructions, communicate notifications, alerts, relay information bidirectionally, etc. The supervisory controller 92 may communicate using wireless or wired transmission paths as identified below. Transmission channels may be direct or via a network 93, and may include a cloud service 94, as further discussed below. Data may be transmitted in raw form or may be processed in whole or part at any one of the car mover controller 115 (FIG. 2), the supervisory controller 92 or the cloud service 94, and such data may be stitched together or transmitted as separate packets.

The hoistway may have charging stations 95a, 95b for charging a power supply 120 (FIG. 2, discussed below) on board the car mover 80. For example, one charging station 95a may be at a top end terminus 70a of the lane 60 of the hoistway 40 and another charging station 95b may be at a bottom end terminus 70b, or any other desired location. For example, there may be a terminus or charging station at one or more intermediate floors. There may also be charging stations at other locations throughout the hoistway.

FIG. 2 is a perspective view of an elevator system 10 including the elevator car 50, a car mover 80, a controller 115, and a power source 120. Although illustrated in FIG. 1 as separate from the car mover 80, the embodiments described herein may be applicable to a controller 115 included in the car mover 80 (i.e., moving through an hoistway 40 with the car mover 80) as a combined control unit 123 with the power supply 121 and may also be applicable a controller located off of the car mover 80 (i.e., remotely connected to the car mover 80 and stationary relative to the car mover 80).

Although illustrated in FIG. 1 as separate from the car mover 80, the embodiments described herein may be applicable to a power source 120 included in the car mover 80 (i.e., moving through the hoistway 40 with the car mover 80) and may also be applicable to a power source located off of the car mover 80 (i.e., remotely connected to the car mover 80 and stationary relative to the car mover 80).

The car mover 80 is configured to move the elevator car 50 within the hoistway 40 and along guide rails 109a, 109b that extend vertically through the hoistway 40. In an embodiment, the guide rails 109a, 109b are T-beams. The car mover 80 includes one or more electric motors 132a, 132b (motors are generally referred to as 132). The electric motors 132a, 132b are configured to move the car mover 80 within the hoistway 40 by rotating one or more motorized wheels 134a, 134b, 134c, 134d that are, in pairs (first pair 134a, 134b, and second pair 134c, 134d) pressed against respective guide beams 111a, 111b, e.g., together forming the car mover track beam 111 (FIG. 1). In an embodiment, the guide beams 111a, 111b are I-beams. It is understood that while an I-beam is illustrated any beam or similar structure may be utilized with the embodiment described herein. Friction between the wheels 134a, 134b, 134c, 134d driven by the electric motors 132a, 132b allows the wheels 134a, 134b, 134c, 134d climb up 21 and down 22 the guide beams 111a, 111b. The guide beam extends vertically through the hoistway 40. It is understood that while two guide beams 111a, 111b are illustrated, the embodiments disclosed herein may be utilized with one or more guide beams. It is also understood that while two electric motors 132a, 132b are illustrated, the embodiments disclosed herein may be applicable to a car mover 80 having one or more electric motors. For example, the car mover 80 may have one electric motor for each of the four wheels 134a, 134b, 134c, 134d (generically wheels 134). The electrical motors 132a, 132b may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 50).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first compression mechanism 150a and the second wheel 134b is compressed against the second surface 112b of the first guide beam 111a by the first compression mechanism 150a. The first compression mechanism 150a compresses the first wheel 134a and the second wheel 134b together to clamp onto, or pinch against, the web portion 113a of the first guide beam 111a.

The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method.

The first compression mechanism 150a may be adjustable in real-time during operation of the elevator system 10 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the hoistway 40, thus creating the track surface 112 for the first wheel 134a and the second wheel 134b to ride on. The flange portions 114a, which may be referred to as track beam sidewalls, may work as guardrails to help guide the wheels 134a, 134b along this track surface and thus help prevent the wheels 134a, 134b from running off track surface.

The first electric motor 132a is configured to rotate the first wheel 134a to climb up 21 or down 22 the first guide beam 111a. The first electric motor 132a may also include a first motor brake 137a to slow and stop rotation of the first electric motor 132a.

The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 50.

The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second compression mechanism 150b and a fourth wheel 134d is compressed against the second surface 112d of the second guide beam 111b by the second compression mechanism 150b. The second compression mechanism 150b compresses the third wheel 134c and the fourth wheel 134d together to clamp onto the web portion 113b of the second guide beam 111b.

The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 10 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the shaft 117, thus creating a track surface for the third wheel 134c and the fourth wheel 134d to ride on. The flange portions 114b may work as guardrails to help guide the wheels 134c, 134d along this track surface and thus help prevent the wheels 134c, 134d from running off track surface.

The second electric motor (otherwise referred to as a wheel drive motor or wheel motor) 132b is configured to rotate the third wheel 134c to climb up 21 or down 22 the second guide beam 111b. The second electric motor 132b may also include a second motor brake 137b to slow and stop rotation of the second motor 132b. The second motor brake 137b may be mechanically connected to the second motor 132b. The second motor brake 137b may be a clutch system, a disc brake system, drum brake system, a brake on a rotor of the second electric motor 132b, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109a proximate the elevator car 50.

The elevator system 10 may also include a position reference system (PRS) 113. The position reference system 121 (otherwise referred to as a sensor) may be mounted on a fixed part at the top of the hoistway 40, such as on a support or guide rail 109, and may be configured to provide position signals related to a position of the elevator car 50 within the hoistway 40. In other embodiments, the position reference system 121 may be directly mounted to a moving component of the elevator system (e.g., the elevator car 50 or the car mover 80), or may be located in other positions and/or configurations.

The position reference system 121 can be any device or mechanism for monitoring a position of an elevator car within the elevator shaft 117. For example, without limitation, the position reference system 121 can be an encoder, sensor, accelerometer, altimeter, pressure sensor, range finder, or other system and can include velocity sensing, absolute position sensing, etc., as will be appreciated by those of skill in the art. The position reference system 121 may communicate with the car mover controller 115 wirelessly or via a wired transmission, using protocols identified herein. Wireless transmission may be direct or via network 93 (FIG. 1) and may include transmissions through a cloud service 94 (FIG. 1). Data from the position reference system 121 may be sent in raw form or may be compiled in whole or part at any one of the position reference system 121, via edge computing, or at the car mover controller 115 or cloud service 94, and portions of the data in any such form may be stitched together or transmitted as separate packets of information.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 50 and the car mover 80. For example, the controller 115 may provide drive signals to the car mover 80 to control the acceleration, deceleration, leveling, stopping, etc. of the elevator car 50.

The controller 115 may also be configured to receive position signals from the position reference system 121 or any other desired position reference device. The data transmitted between the controller 115 and position reference system 121 may be obtained and processed separately and stitched together, or processed at one of the two components, and may be processed in a raw or complied form.

When moving up 21 or down 22 within the hoistway 40 along the guide rails 109a, 109b, the elevator car 50 may stop at one or more floors 30a, 30b as controlled by the controller 115. In one embodiment, the controller 115 may be located remotely or in the cloud. In another embodiment, the controller 115 may be located on the car mover 80

The power supply 120 for the elevator system 10 may be any power source, including a power grid and/or battery power which, in combination with other components, is supplied to the car mover 80. In one embodiment, power source 120 may be located on the car mover 80. In an embodiment, the power supply 120 is a battery that is included in the car mover 80. The elevator system 10 may also include an accelerometer 107 attached to the elevator car 50 or the car mover 80. The accelerometer 107 is configured to detect an acceleration and/or a speed of the elevator car 50 and the car mover 80.

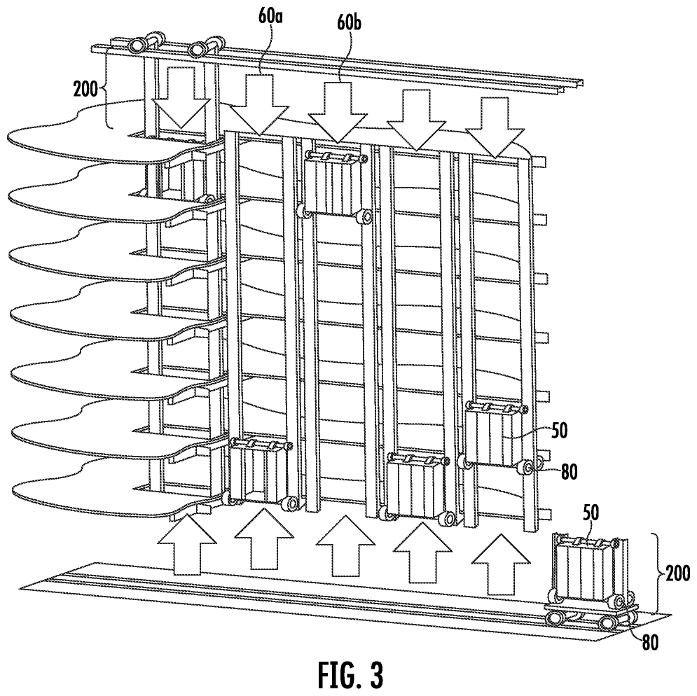

Turning to FIG. 3 the above disclosed car mover 80 may utilize a transfer station 200 (or robotic transporters) that enable lateral motion such that an elevator car 50 may be removed from one hoistway lane 60a and inserted into another 60b, moved into storage, or moved into a maintenance area, etc. This may result in a “dynamic length hoistway” for the elevator car 50, where the effective position of the top and bottom motion ranges will change depending on whether the transfer station 200 is present.

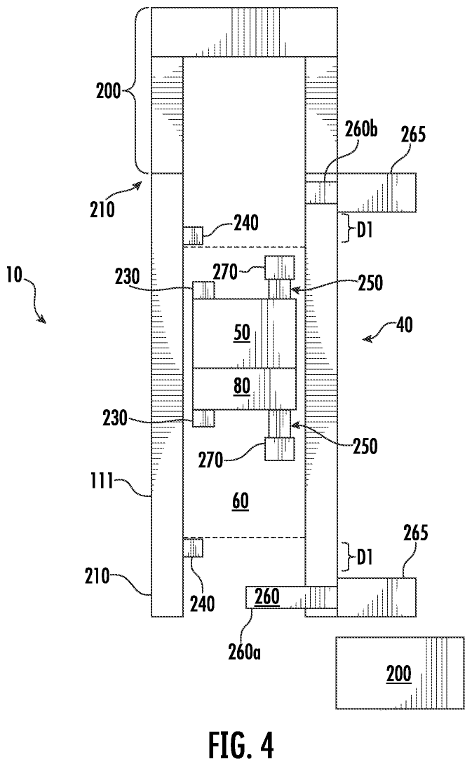

Turning to FIG. 4, the elevator system 10 is configured for controlling motion of the elevator car 50 in the hoistway 40. The hoistway 40 (i.e., via the hoistway lane 60) has a bottom transfer station end 210a and a top transfer station end 210b (generally referred to as a transfer station end 210) that is configured to receive the transfer station 200. In other configurations, there may be a transfer station at one or more intermediate floors, or at other locations throughout the hoistway. The system includes the car mover 80 operationally connected to the elevator car 50 for moving the elevator car 50 in the hoistway 40.

According to embodiments, the car mover 80 is configured with motion stopping implements, e.g., enabling the car mover 80 to stop while approaching the transfer station end 210 one or both of the top and bottom of the hoistway 40 (defining upper and/or lower transfer station ends) when the transfer station 200 is unavailable. The motion stopping implements may be in the form of controls executable by the controller 115 (FIG. 2) and/or hardware operationally connected to the controller 115, or operating independently of the controller 115, as indicated herein. The station 200 may be unavailable as shown in FIG. 3 because it is in the process of transferring another elevator car 50. The car mover 80 may be configured to stop by controlling one or more of primary and safety brakes (e.g., brakes 137, 138 shown in FIG. 2 and discussed above) operationally connected to the controller, and power for moving in the hoistway. In another implementation, the car mover 80 may be configured to stop by stopping motion of the drive wheels.

In one embodiment, the car mover 80 may be configured to stop upon determining that it is within a predetermined distance D1, which can be any desired distances, such as between six and thirty six inches of the transfer station end 210 of the hoistway 40. In one embodiment, the car mover 80 may be configured to determine from sensor data that it is within the predetermined distance of the transfer station end 210 of the hoistway 40. The sensor data may be obtained from the sensor 121 (FIG. 2) that is operationally connected to the car mover 80.

In one embodiment, the car mover 80 may be configured to determine that it is within a predetermined distance D1 of one or both of the top and bottom transfer station ends 210 of the hoistway 40 when a limit switch 230, operationally connected to one or both of the top and bottom of the elevator car, e.g., via the car mover 80 at the bottom of the elevator car (defining upper and/or lower limit switches), is engaged by an actuator 240 at a respective one or both of the top and bottom of the hoistway (defining upper and/or lower actuators). In one embodiment the actuator 240 is located in the hoistway 40, e.g., connected to the track 111. The actuator 240 may be within the predetermined distance of the transfer station end 210 of the hoistway 40. In other embodiments the actuator 240 is operationally connected to the car mover 80 or elevator car 50. The actuator 240 may be engage wirelessly with the limit switch 230 and/or the lockout device 260, e.g., using Bluetooth, RFID, Wifi, Zigbee, Zwave or other wireless platform. The actuator 240 should, in one embodiment, be able to physically engage the limit switch 230, e.g., by contacting the limit switch 230 when they are close to each other. Some embodiments may use wireless connection, other may use physical, wired connections, and yet other embodiments may use a combination of different types and platforms of connections.

A motion buffer 250 at one or both of the top and bottom of the elevator car, e.g., via the car mover 80 at the bottom of the elevator car (defining upper and/or lower motion buffers), is configured to engage a barrier 260 (or lockout device) respectively at a one or both of the top and bottom of the hoistway (defining upper and/or lower barriers), that is located adjacent the transfer station end 210 of the hoistway 40, and is deployed into a travel path of the car mover 80 or elevator car 50 (which are illustrated as being the same travel path, though that is not a requirement) when the transfer station 200 is unavailable. When the motion buffer 250 engages the barrier 260, the car mover 80 stops. In one embodiment the motion buffer 250 is operationally connected to the car mover 80. In other embodiments the motion buffer 250 is operationally connected to the elevator car 50 or hoistway 40. In one embodiment, the motion buffer 250 is illustrated as a piston type buffer, e.g., including a piston 270 at one or both of the top and bottom of the elevator car, e.g., via the car mover 80 at the bottom of the elevator car (defining upper and/or lower pistons), configured to react to cushion forces generated from engagement of the motion buffer 250 with the barrier 260. In other embodiments the motion buffer 250 may be a spring, elastomer, or there damper type implement. In one embodiment, the barrier 260 functions as a motion buffer, e.g., as a shock absorber.

One or both of the barrier 260 and the motion buffer 250 is configured for being in a deployed state when the transfer station 200 is unavailable and a retracted state when the transfer station 200 is available. In the deployed state, the barrier 260 is extended into the travel path of the motion buffer 250 to block access to the transfer station end of the hoistway 40. In the retracted state, the barrier 260 is drawn into a barrier housing 265 at one or both of the top and bottom of the hoistway (defining upper and/or lower barrier housings), outside of the travel path of the motion buffer 250. The barrier 260 is configured to automatically transition into the deployed state when the transfer station 200 is unavailable. In one embodiment, without the motion buffer 250, the barrier 260 may be utilized, located and operated as indicated, to deploy in the path of the elevator and/or car mover. Thus, with the above embodiments, as indicated, the. The car mover 80 is configured to stop while approaching either transfer station end 210 of the hoistway 40 upon determining that the respective transfer station 200 is unavailable.

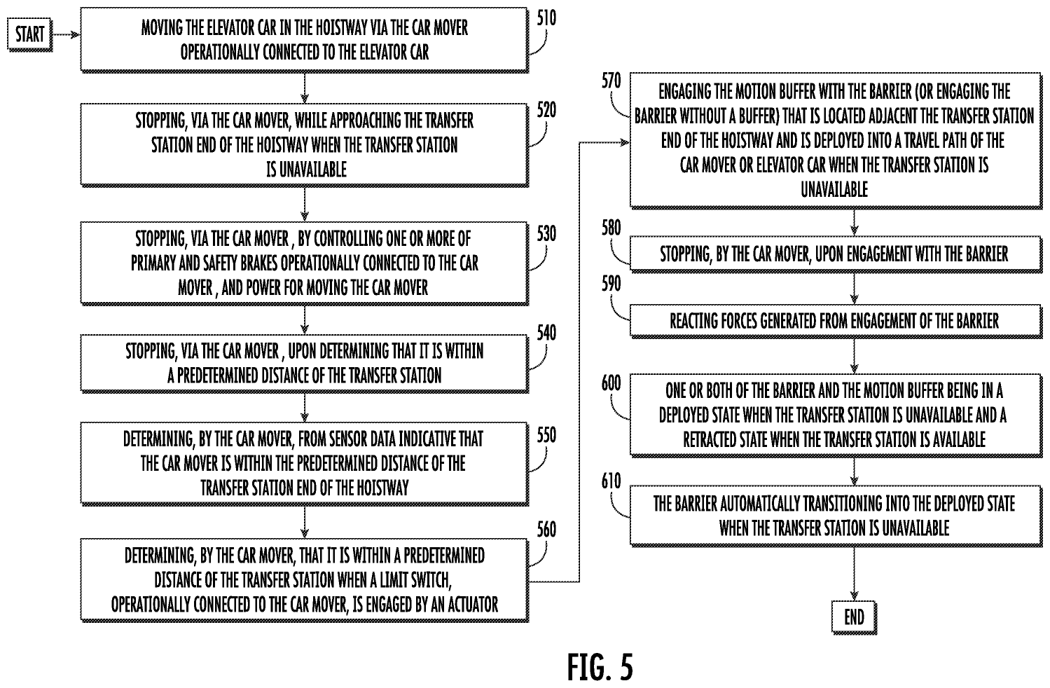

Turning to FIG. 5, a flowchart shows a method of operating the elevator system 10 to control motion of the elevator car 50 in the hoistway 40. As shown in block 510, the method includes moving the elevator car 50 in the hoistway 40 via the car mover 80 operationally connected to the elevator car 50. As shown in block 520, the method includes stopping, via the car mover 80, while approaching the transfer station end 210 of the hoistway 40 when the transfer station 200 is unavailable.

As shown in block 530, the method includes stopping, via the car mover 80, by controlling one or more of primary and safety brakes operationally connected to the car mover 80, and power for moving the car mover 80. As shown in block 540, the method includes stopping, via the car mover 80, upon determining that it is within a predetermined distance of the transfer station 200 end of the hoistway 40. As shown in block 550, the method includes determining, by the car mover 80, from sensor data indicative that the car mover 80 is within the predetermined distance of the transfer station end 210 of the hoistway 40. The sensor data is obtained from the sensor 121 that is operationally connected to the car mover 80. As shown in block 560, the method includes determining, by the car mover 80, that it is within a predetermined distance of the transfer station end of the hoistway when a limit switch 230, operationally connected to the car mover 80, is engaged by an actuator 240. In one embodiment the actuator 240 is located in the hoistway 40. The actuator 240 is located within the predetermined distance of the transfer station end 210 of the hoistway 40. In other embodiments the actuator 240 is operationally connected to the car mover 80 or elevator car 50.

As shown in block 570, the method includes engaging the motion buffer 250 with the barrier 260 (or in embodiments without the buffer 250, engaging the barrier 260, e.g., with the elevator car or car mover) that is located adjacent the transfer station end 210 of the hoistway 40 and is deployed into a travel path of the car mover 80 or elevator car 50 when the transfer station 200 is unavailable. In one embodiment the motion buffer 250 is operationally connected to the car mover 80. In other embodiments the motion buffer 250 is operationally connected to the elevator car 50 or hoistway 40. As shown in block 580, the method includes stopping, by the car mover 80, upon engaging the barrier 260. As shown in block 590, the method includes reacting forces generated from engagement with the barrier 260. In embodiments with a motion buffer 250, forces are at least partially reacted with it. In embodiments without a motion buffer 250, the barrier 260 may be configured to react forces as a buffer.

As shown in block 600, the method includes one or both of the barrier 260 and the motion buffer 250 being in a deployed state when the transfer station 200 is unavailable and a retracted state when the transfer station is available. In the deployed state, the barrier 260 is extended into the travel path of the car mover 80 or elevator car 50 to block access to the transfer station end 210 of the hoistway 40. In the retracted state, the barrier 260 is outside of the travel path of the car mover 80 or elevator car 50. As shown in block 610, the method includes the barrier 260 automatically transitioning into the deployed state when the transfer station 200 is unavailable.

Thus, the above disclosed embodiments provide a system and a method of ensuring that self-propelled elevator cars do not move past a safely traversable space by implementing a limit switch style device that is enabled when a transfer station 200 is not present, which can lockout or depower the propulsion means (the car mover 80) on the elevator car 50. This device may be mechanical and lockout/depower the propulsion means when it physically contacts the car mover 80 or elevator car 50. The device may be electrically implemented and communicate a stop/lockout/depower command to the car mover 80. This system and method may be supplemented by a mechanical stop built in the hoistway 40 itself to prevent an unsuccessfully deactivated car mover 80 from continuing off the rails. When a transfer station 200 is present, the lockout/depowering device may be disabled so that the car mover 80 may move off of the fixed rails and into the transfer station 200 via its rails. The embodiments are functionally similar to a safety chain item on an elevator car 50, however unlike a traditional safety chain, it may be enabled or disabled depending on the presence of a transfer station 200. The embodiment may be located at the ends (top and bottom) of the hoistway 40 and only disable the car mover 80 when it comes within proximity or physically contacts the device. Benefits of this system includes preventing car movers 80 from running off the end of the hoistway rails when a transfer station 200 is not present.

Wireless connections identified above may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub-1Ghz RF equipment operates in the ISM (industrial, scientific and medical) spectrum bands below Sub 1 Ghz—typically in the 769-935 MHz, 315 Mhz and the 468 Mhz frequency range. This spectrum band below 1 Ghz is particularly useful for RF IOT (internet of things) applications. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). The above is not intended on limiting the scope of applicable wireless technologies.

Wired connections identified above may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

As indicated, when data is transmitted over a network between end processors, the data may be transmitted in raw form or may be processed in whole or part at any one of the end processors or an intermediate processor, e.g., at a cloud service or other processor. The data may be parsed at any one of the processors, partially or completely processed or complied, and may then be stitched together or maintained as separate packets of information.

Each processor identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium. Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system configured for controlling motion of an elevator car in a hoistway, the hoistway having a transfer station end that is configured to receive a transfer station,
the system comprising:
a car mover is operationally connected to the elevator car for moving the elevator car in the hoistway,
wherein the car mover is configured to stop while approaching a transfer station when the transfer station is unavailable.

2. The elevator system of claim 1, wherein:
the car mover is configured to stop by controlling one or more of primary and safety brakes operationally connected to the car mover, and power for moving in the hoistway.

3. The elevator system of claim 1, wherein:
the car mover is configured to stop upon determining that it is within a predetermined distance of the transfer station.

4. The elevator system of claim 3, wherein the car mover is configured to determine from sensor data that it is within the predetermined distance of the transfer station,
wherein the sensor data is obtained from a sensor that is operationally connected to the car mover.

5. The elevator system of claim 1, wherein:
the car mover is configured to determine that it is within a predetermined distance of the transfer station when a limit switch, operationally connected to the car mover, is engaged by an actuator, within the predetermined distance of the transfer station.

6. The elevator system of claim 1, wherein:
a motion buffer is configured to engage a barrier that is located adjacent the transfer station end of the hoistway and is deployed into a travel path of the car mover or the elevator car when the transfer station is unavailable, wherein when the motion buffer engages the barrier, the car mover stops, and wherein motion buffer is configured to react forces generated from engagement of the motion buffer with the barrier.

7. The elevator system of claim 1, wherein:
a barrier is located adjacent the transfer station end of the hoistway and is deployed into a travel path of the car mover or the elevator car when the transfer station is unavailable, wherein upon engaging the barrier, the car mover stops, wherein the barrier is configured to react forces generated from engagement with the barrier.

8. The elevator system of claim 6, wherein:
wherein one or both of the barrier and buffer is configured for being in a deployed state when the transfer station is unavailable and a retracted state when the transfer station is available,
wherein in the deployed state, the barrier is extended into the travel path of the car mover or the elevator car to block access to the transfer station, and
in the retracted state, the barrier is outside of the travel path of the car mover or the elevator car.

9. The elevator system of claim 8, wherein:
the barrier is configured for automatically transition into the deployed state when the transfer station is unavailable.

10. The elevator system of claim 6, wherein:
the transfer station end is a lower transfer station end and the transfer station is a lower transfer station, and wherein
the hoistway defines an upper transfer station end that is configured to receive an upper transfer station, and
wherein the car mover is configured to stop while approaching the upper transfer station upon determining that the upper transfer station is unavailable.

11. The elevator system of claim 10, wherein:
the motion buffer is a lower motion buffer and the barrier is a lower barrier, and
a upper motion buffer is operationally connected to the elevator car and configured to engage a upper barrier that is located adjacent the upper transfer station and is deployed into the travel path of the car mover or the elevator car when the upper transfer station is unavailable,
wherein the car mover is configured to stop when the upper motion buffer engages the upper barrier.

12. A method of operating an elevator system to control motion of an elevator car in a hoistway, the hoistway having a transfer station end that is configured to receive a transfer station,
the method comprising:
moving the elevator car in the hoistway via a car mover operationally connected to the elevator car,
stopping, via the car mover, while approaching the transfer station when the transfer station is unavailable.

13. The method of claim 12, comprising:
stopping, via the car mover, by controlling one or more of primary and safety brakes operationally connected to the car mover, and power for moving the car mover.

14. The method of claim 12, comprising:
stopping, via the car mover, upon determining that it is within a predetermined distance of the transfer station.

15. The method of claim 14, comprising:
determining, by the car mover, from sensor data indicative of the car mover being within the predetermined distance of the transfer station, wherein the sensor data is obtained from a sensor that is operationally connected to the car mover.

16. The method of claim 12, comprising:
determining, by the car mover, that it is within a predetermined distance of the transfer station when a limit switch, operationally connected to the car mover, is engaged by an actuator, within the predetermined distance of the transfer station.

17. The method of claim 12, comprising:
engaging a motion buffer with a barrier that is located adjacent the transfer station and is deployed into a travel path of the car mover or the elevator car when the transfer station is unavailable, stopping, by the car mover, upon the motion buffer engaging the barrier, and
reacting forces generated from engagement of the motion buffer with the barrier via the motion buffer.

18. The method of claim 12, comprising:
engaging a barrier that is located adjacent the transfer station and is deployed into a travel path of the car mover or the elevator car when the transfer station is unavailable,
stopping, by the car mover, upon engagement with the barrier, and
reacting, by the barrier, forces generated from engagement with the barrier.

19. The method of claim 17, comprising:
one or both of the barrier and the motion buffer being in one of a deployed state when the transfer station is unavailable and a retracted state when the transfer station is available,
wherein in the deployed state, the barrier is extended into the travel path of the car mover or the elevator car to block access to the transfer station, and
in the retracted state, the barrier is outside of the travel path of the car mover or the elevator car.

20. The method of claim 19, comprising:
the barrier automatically transitioning into the deployed state when the transfer station is unavailable.
